(19) United States
(12) Patent Application Publication
(10) Pub. No.: US 2015/0316954 A1
(43) Pub. Date: Nov. 5, 2015

(54) RETRACTABLE WIRE SYSTEMS FOR MOBILE DEVICES

(71) Applicants: Guy Madison, Marysville, WA (US); Richard Madison, Tulalip, WA (US)

(72) Inventors: Guy Madison, Marysville, WA (US); Richard Madison, Tulalip, WA (US)

(21) Appl. No.: 14/270,114

(22) Filed: May 5, 2014

(51) Int. Cl. G06F 1/16

(52) U.S. Cl. CPC G06F 1/16

(57) ABSTRACT

Retractable wire systems for mobile devices include a wire and a winding mechanism within a housing for the mobile device. The wire is configured to provide electrical communication between the mobile device and an accessory for the mobile device. The winding mechanism is configured to releasably wind the wire, the wire being selectively moveable between a wound position and an unwound position. In some examples, the housing is integral to a rear wall of the mobile device. In some further examples, the housing is a mobile device cover releasably attachable to an outer surface of the mobile device.

### BACKGROUND

The present disclosure relates generally to retractable wire systems for mobile devices. In particular, retractable wire systems for mobile device accessories are described.

Known mobile device accessories that include a wire (e.g., power cords, data transfer cords, headphones, etc.) are not entirely satisfactory for the range of applications in which they are employed. For example, existing mobile device accessories are separate from a mobile device and are stored separately from a mobile device. A user, therefore, must remember to carry the accessory along with the mobile device during travel. In addition, conventional mobile device accessories are small and can easily be lost and/or difficult to locate. In both of these examples, the user may not have access to a mobile device accessory when desired.

In even another example, conventional mobile device accessories that include a wire are often stored in a user's bag with other personal items. During normal transaperture and/or use of the bag, the wire of the mobile device may become tangled. In this example, the mobile device accessory may be damaged and/or broken over time. Further, a user may be required to untangle the cord prior to use, delaying use of the mobile device accessory.

Thus, there exists a need for mobile device accessories that improve upon and advance the design of known mobile device accessories. Examples of new and useful mobile device accessories relevant to the needs existing in the field are discussed below.

Disclosure addressing one or more of the identified existing needs is provided in the detailed description below. Examples of references relevant to retractable wire systems for mobile devices and mobile device accessories include U.S. Patent Reference: U.S. Pat. No. 7,900,863. The complete disclosure of the above patent is herein incorporated by reference for all purposes.

### SUMMARY

The present disclosure is directed to retractable wire systems for mobile devices including a wire and a winding mechanism within a housing for the mobile device. The wire is configured to provide electrical communication between the mobile device and an accessory for the mobile device. The winding mechanism is configured to releasably wind the wire, the wire being selectively moveable between a wound position and an unwound position. In some examples, the housing is integral to a rear wall of the mobile device. In some further examples, the housing is a mobile device cover releasably attachable to an outer surface of the mobile device.

### BRIEF DESCRIPTION OF THE DRAWINGS

FIG. 1 is a perspective view of a first example of a retractable wire system for a mobile device accessory, where the accessory is a headphone in a wound position.

FIG. 2 is a perspective view of the first example of a retractable wire system for a mobile device accessory shown in FIG. 1, where the accessory is a headphone in an unwound position.

FIG. 3 is a perspective view of the first example of a retractable wire system for a mobile device accessory shown in FIG. 1 depicted without an associate mobile device.

FIG. 4 is an exploded view of the first example of a retractable wire system for a mobile device accessory.

FIG. 5 is a front elevation view of a winding mechanism for a retractable spring of the first example of a retractable wire system for a mobile device accessory of FIG. 1.

FIG. 6 is a front elevation view of a retractable spring of the first example of a retractable wire system for a mobile device accessory of FIG. 1.

FIG. 7 is a perspective view of a second example of a retractable wire system for a mobile device accessory including a retractable spring that is integral to a body of the mobile device.

FIG. 8 is a perspective view of a third example of a retractable wire system for a mobile device accessory, where the accessory is a universal serial bus.

### DETAILED DESCRIPTION

The disclosed retractable wire systems for mobile devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various retractable wire systems for mobile devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific aperturerayal of a related feature in any given figure or example.

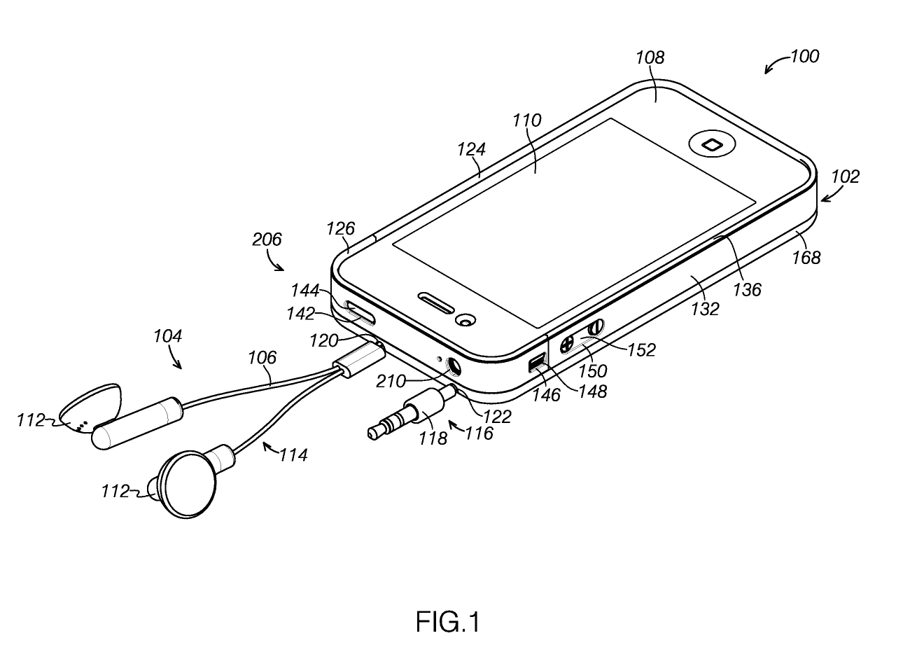

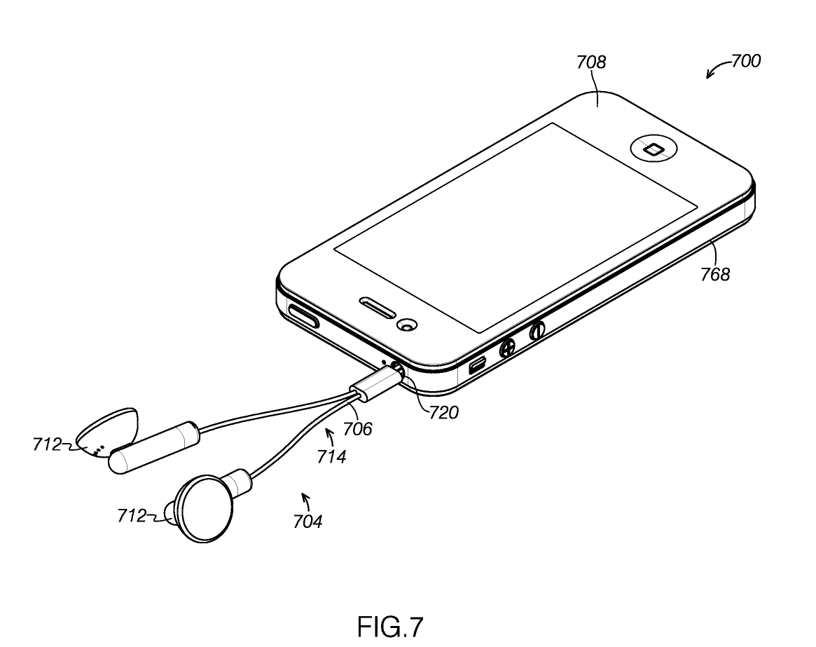

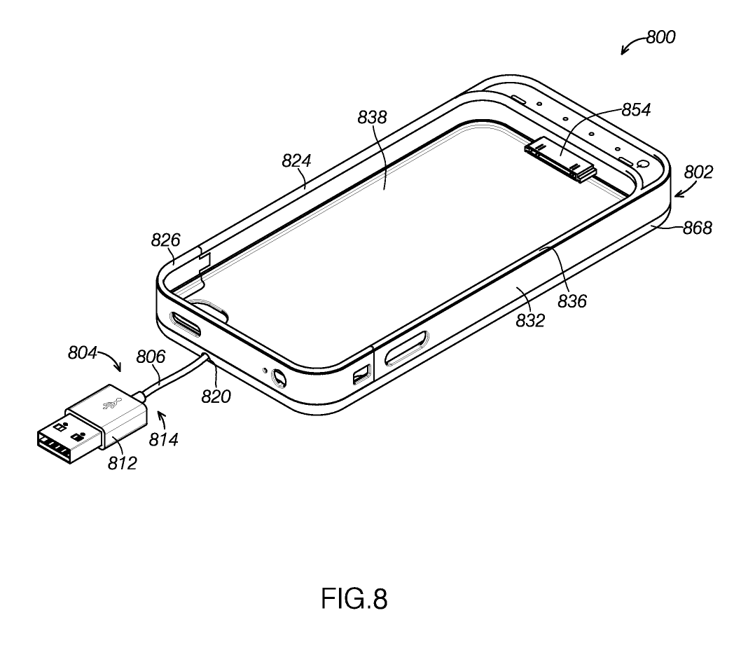

FIGS. 1-8 show example retractable wire systems for mobile device accessories. In a first example, shown in FIGS. 1-6, a retractable wire system for a mobile device accessory is integral to a removable cover for a mobile device. The removable cover can be releasably attached to a mobile device. In the example system of FIGS. 1-6, the mobile device accessory is a headphone. In a second example, shown in FIG. 7, a retractable wire system for a mobile device is integral to a rear wall of the body of the mobile device. In the example system of FIG. 7, the mobile device accessory is a headphone. In a third example, shown in FIG. 8, a retractable wire system for a mobile device accessory is integral to a removeable cover for a mobile device. In the example system of FIG. 8, the mobile device accessory is a universal serial bus (USB). In each of the above examples, a retractable wire system is disposed within a housing for the mobile device (e.g., a cover for the mobile device or an outer wall of the mobile device body). It will be appreciated that in other examples, the mobile device accessory can be any mobile device accessory including a wire that is known or yet to be discovered.

The presently described example retractable wire systems for mobile device accessories address the issues for conventional mobile device accessories described above. For example, as the mobile device accessories are attached to the mobile device, a user does not need to remember to additionally pack and/or store the accessory with the mobile device during travel. Moreover, the mobile device accessories are less likely to be lost as they are attached to the mobile device. In another example, the retractable wire system prevents tangling of a wire during storage and/or transportation of a mobile device accessory. Therefore, using the presently described retractable wire systems for mobile device accessories, a user is more likely to have immediate access to the mobile device accessory when desired.

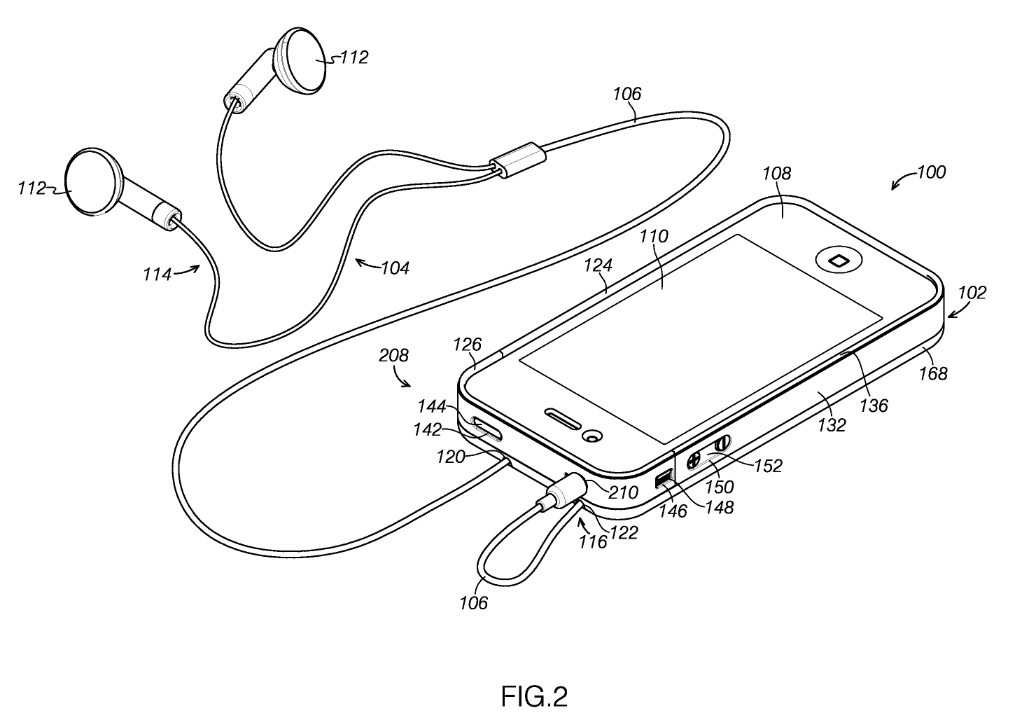

With reference to FIGS. 1-6, a first example of a retractable wire system for a mobile device, retractable wire system 100, will now be described. Retractable wire system 100 includes a mobile device cover 102 and a mobile device accessory 104 having a wire 106. In FIGS. 1 and 2, retractable wire system 100 is depicted with an associated mobile device 108 including a display 110.

In the present example, mobile device accessory 104 is a pair of headphones 112 (e.g., ear buds) at a first end 114 of the wire. Further, in the present example, a second end 116 of the wire includes an audio jack plug 118. First end 114 is extended and extendable through an aperture 120 in mobile device cover 102, while second end 116 is extended through a second aperture 122 of mobile device cover 102. An aperture 210 is aligned with an audio jack socket 140 of mobile device 110. Therefore, as depicted in FIG. 2, audio jack 116 can be inserted through aperture 210 into the audio jack socket of mobile device 102. It will be appreciated that the audio jack is selectively insertable into and removable from the audio jack socket.

In alternate examples, the mobile device cover and the mobile device can include selectively matable electrical coupling partners instead of an audio jack and audio jack socket. In these alternate examples the second end of the wire is can be coupled to a first electrical mating partner (e.g., a metallic chip) disposed on an inner wall of the mobile device cover. The mobile device can include a second electrical mating partner specifically configured to and located in a position to mate with the first electrical mating partner when the mobile device cover is engaged with the mobile device. Accordingly, when the mobile device cover is engaged with the mobile device the first electrical mating partner makes surface-to-surface contact with the second electrical mating partner.

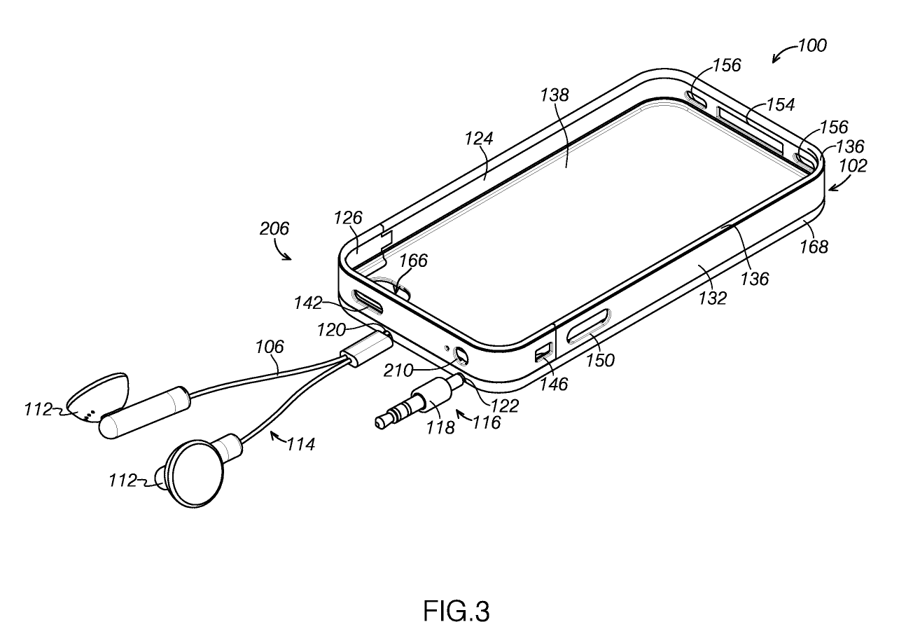

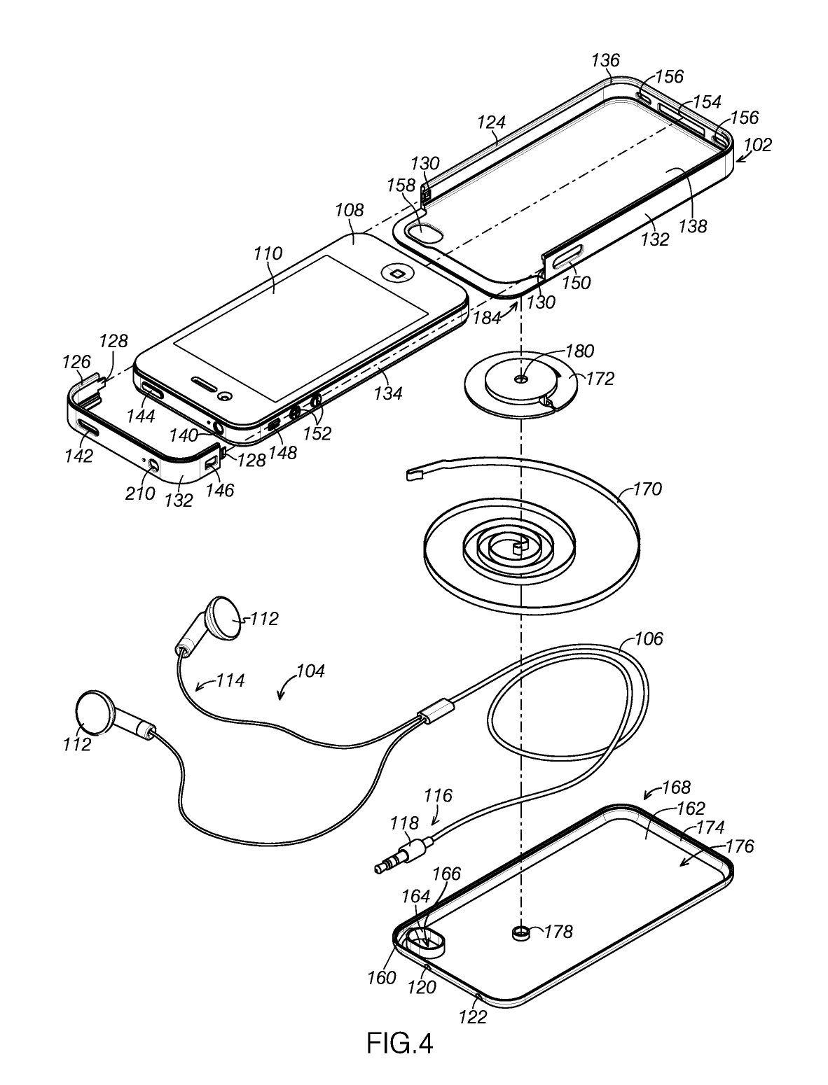

As shown in FIGS. 1-4, mobile device cover 102 includes a main body 124 and a snap-fit capping member 126. As depicted in FIG. 4, a pair of tabs 128 on capping member 126 are selectively snap-fit over a pair of complimentarily configured receiving flanges 130 of main body 124. When snap-fitted together, main body 124 and capping member 126 collectively form a protective perimeter wall 132 that encompasses a perimeter wall 134 of mobile device 108. Alternatively, as depicted in FIG. 3, capping member 126 can be snap-fitted to main body 124 without being fitted around a mobile device.

Perimeter wall 132 includes an overhanging lip 136 that is partially extended over a top of mobile device 108. Overhanging lip 136 is only partially extended over the top surface of mobile device 108 so as not to obstruct display 110, while retaining mobile device 110 between overhanging lip 136 and an internal wall 138. It will be appreciated that in alternate examples, the overhanging lip may be comprised of a deformable and/or elastic material (i.e., a material having elastic memory) and the cover main body can be one piece (i.e., a cover not have a separate capping member). In these alternate examples, the cover may be snap-fit over the phone via the deformable overhanging lip. It will be appreciated that the cover may be releasably attached to the mobile device via any mechanism already known or yet to be discovered.

Returning to FIGS. 1-4, perimeter wall 132 further includes a plurality of apertures configured to allow a user access to various inputs, outputs, and/or buttons of mobile device 108. In the present example, perimeter wall 132 includes aperture 122 for accessing audio jack 140, an aperture 142 for accessing a power button 144, an aperture 146 for accessing a ringer button 148, an aperture 150 for accessing volume control 152, an aperture 154 for accessing a dock connector (not specifically shown), and apertures 156 for accessing internal speakers and/or microphones of the mobile device (not specifically shown. It will be appreciated that the perimeter wall can include more or fewer apertures depending on the specific design of the mobile device that will be used in combination with the retractable wire system.

Similar in function to the plurality of apertures in perimeter wall 132, internal wall 138 includes an aperture 158 for allowing access and/or unobstructed view for a camera (not specifically shown) of mobile device 110. Aperture 158 is aligned with an aperture 160 in an external wall 162. Aperture 160 includes a wall 164 that creates and continuous channel 166 between apertures 158 and 160 so that light projected from a flash of the camera and/or light coming into the camera is unobstructed by mobile device cover 102.

As shown in FIG. 4, external wall 162 is an external portion of a spring housing 168 for retaining a spring 170, a spring winding mechanism 172, and wire 106. Spring housing 168 further includes a perimeter wall 174 with a retaining space 176 disposed between external wall 162, perimeter wall 174, and internal wall 138. A center hole 180 of winding mechanism is configured to be rotatably attached an internal projection 178 on an inner surface of external wall 162 so that winding mechanism 172 is rotatable around internal projection 178 within retaining space 176.

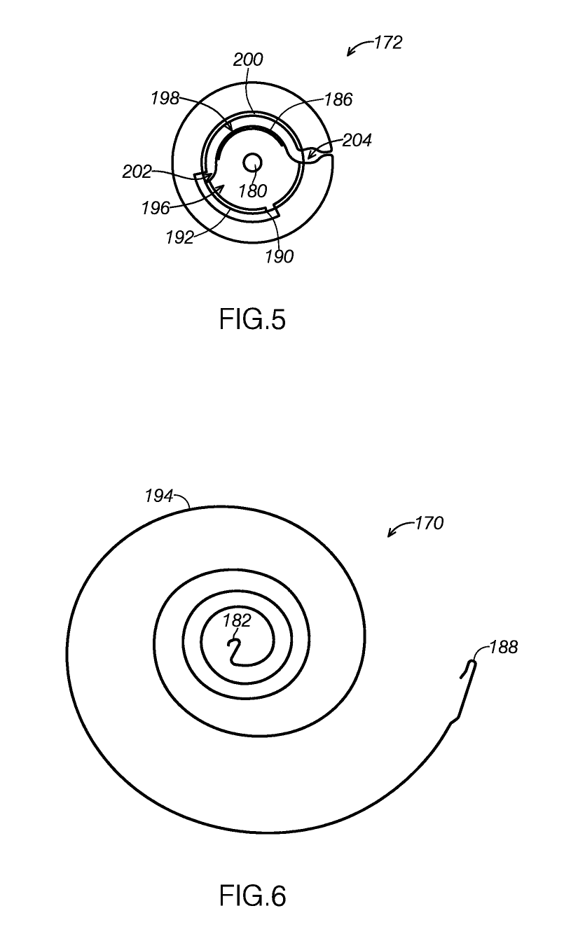

More detailed view of winding mechanism 172 and spring 170 are shown in FIGS. 5 and 6, respectively. Spring 170 includes a first hook 182 that is configured to hook around projection 178 and a second hook 188 that is configured to hook around a first end 190 of a curved wall 192. Thus, a coiling body 194 of spring 170 can be tightly wound (i.e., coiled) and disposed within a central space 196 of winding mechanism 172 when the hooks are engaged with (i.e., hooked around) the walls of the winding mechanism. It will be appreciated that spring 170 is shown in FIG. 6 in a relatively unwound (i.e., relatively uncoiled) position so that the structure of the spring is apparent. It will be further appreciated that when spring 170 is tightly wound, adjacent coiled faces of coiling body 194 may be in contact.

A wire receiving channel 198 is defined by an inner curved wall 184 and an outer curved wall 200. Wire receiving channel 198 includes a first opening 202 and a second opening 204 where a first side of wire 106 (e.g., a side proximal to first end 114) and a second side of wire 106 (e.g., a side proximal to second end 116) can be fitted and retained.

Spring 170 is configured to bias wire 106 in a wound position 206 (shown in FIGS. 1 and 3). In the wound position, the wire is generally wound around winding mechanism 172 (not specifically shown) and is contained within retaining space 176. First end 114 and second end 116 (i.e., the locations of headphones 112 and audio jack 118) remain outside of retaining space 176. Further, in the wound position, spring 170 is in a more relaxed and less coiled position.

By pulling on an end of the wire 106 (e.g., first end 114 and/or second end 116), wire 106 can be moved to an unwound position 208 (shown in FIG. 2). Winding mechanism 172 is rotated to during unwinding of wire 106. In the unwound position, a desired length of the wire can be extended out from the retaining space 176 so that audio jack 118 can be plugged in to audio jack socket 140 and headphones 112 can be extended to a length to be inserted into the ears of a user. Further, in the unwound position, spring 170 is in a less relaxed and more coiled position. This position of the spring allows for a biasing force to return the wire to the wound position.

Furthermore, in unwound position 208, wire 106 is prevented from automatically returning to wound position 206 via a catch mechanism, and the wire 106 is pulled past the catch mechanism, the wire is automatically retracted and moved into the wound position 206. Accordingly, the wire can be pulled out and/or extended to where it passes the catch point of the catch mechanism to maintain the unwound position. The wire can be pulled again past the catch point of the catch mechanism to retract that wire into the wound position. It will be appreciated that the wire is selectively moveable between the wound position and the unwound position as desired during use (i.e., the wire can be extended and reatracted).

As stated above, mobile device cover 102 includes a main body 124 and a snap-fit capping member 126. As shown in FIG. 4, for use with mobile device 108, pair of tabs 128 on capping member 126 are snap-fit over complimentarily configured receiving flanges 130 of main body 124. When snap-fitted together, main body 124 and capping member 126 collectively form a protective perimeter wall 132 that encompasses perimeter wall 134 of mobile device 108 and overhanging lip 136 is partially extended over a top of mobile device 108. Mobile device 108 is then retained within perimeter wall 132 and between overhanging lip 136 and internal wall 138.

Also stated above, wire 106 of mobile device accessory 104 is selectively moveable between wound position 206 and unwound position 208 (i.e., the wire is selectively extended and retracted). The wire can be selectively moved to the unwound position by pulling to extend the wire to the catch point of the catch mechanism. The wire can be selectively retracted to the wound position by pulling the wire past the catch point and allowing the spring baising force to wind the wire around the winding mechanism.

In the wound position, wire 106 is wound around winding mechanism 172 and stored in retaining space 176. In the unwound position, mobile device accessory 104 is in a position to be used by the user. For example, headphones 112 can be inserted into the ears of the user and audio jack 118 can be inserted into audio jack socket 140. In some examples, the first end of the wire can be retracted, while the audio jack can remain in the audio jack socket (i.e., the second end of the wire remains extended).

Thus, retractable wire system 100 functions to provide a mobile device accessory that is selectively attachable to the mobile device. The presently described system has the advantage that the user does not have to remember to additionally pack, store, and/or carry the mobile device accessory with the mobile device. Further, the presently described system has the advantage that the mobile device accessory does not have to be located and/or found by the user separately from the mobile device when use is desired. Additionally or alternatively, retractable wire system 100 can be used to maintain an untangled condition of a wire of the mobile device accessory during storage and/or transport of the mobile device accessory. Furthermore, retractable wire system 100 is configured to provide a protective covering for the associated mobile device and can be removed from the mobile device as desired by the user.

Turning attention to FIG. 7, a second example retractable wire system, retractable wire system 700, will now be described. Retractable wire system 700 includes many similar or identical features to retractable wire system 100. Thus, for the sake of brevity, each feature of retractable wire system 700 will not be redundantly explained. Rather, key distinctions between retractable wire system 700 and retractable wire system 100 will be described in detail and the reader should reference the discussion above for features substantially similar between the two retractable wire systems.

As can be seen in FIG. 7, retractable wire system 700 includes a mobile device 708 and a mobile device accessory 704. Unlike retractable wire system 100, mobile device accessory 704 is not a portion of a cover for a mobile phone. Instead, mobile device accessory 704 is integral to mobile device 708.

In this example, a spring housing 768 is a rear wall of mobile device 708. It will be appreciated that spring housing 768 can house a spring, a winding mechanism, and a catch mechanism as described above for retractable wire system 100. Further, a first end 714 of a wire 706 can be pulled through an aperture 720 to move the wire between a wound position (similar to wound position 206 shown in FIG. 1) and an unwound position (similar to unwound position 208 shown in FIG. 2). In this example, mobile device accessory is permanently attached to mobile device 708. Therefore, a second end of the wire is electrically coupled to and in communication with the mobile device via a connection to internal electrical components of the mobile device (i.e., excluding an audio jack).

Thus, retractable wire system 700 functions to provide a mobile device accessory that is permanently attached to the mobile device. The presently described system has the advantage that the user does not have to remember to additionally pack, store, and/or carry the mobile device accessory with the mobile device. Further, the presently described system has the advantage that the mobile device accessory does not have to be located and/or found by the user separately from the mobile device when use is desired. Additionally or alternatively, retractable wire system 700 can be used to maintain an untangled condition of a wire of the mobile device accessory during storage and/or transport of the mobile device accessory. Furthermore, retractable wire system 700 is configured to have a slender profile that is substantially the profile of the mobile device.

Turning attention to FIG. 8, a third example retractable wire system, retractable wire system 800, will now be described. Retractable wire system 800 includes many similar or identical features to retractable wire system 100. Thus, for the sake of brevity, each feature of retractable wire system 800 will not be redundantly explained. Rather, key distinctions between retractable wire system 800 and retractable wire system 100 will be described in detail and the reader should reference the discussion above for features substantially similar between the two retractable wire systems.

As can be seen in FIG. 8, retractable wire system 800 includes a mobile device cover 802 and a mobile device accessory 804 having a wire 806. Unlike retractable wire system 100, mobile device accessory 806 is a USB cable. Thus, mobile device accessory 804 can be used to provide power to a mobile device and/or provide data communication between a mobile device and another device (e.g., a computer, a tablet, another mobile device, etc.). Further, in this example, mobile device cover 806 includes a mobile device dock 854 on an inner wall of the mobile device cover that is configured to be insertable into a receiving port of a mobile device.

Mobile device cover 802 includes a capping member 826 that can be selectively snap-fit to a main body 824 to form a perimeter wall 832 having an overhanging lip 836. Although not specifically shown in FIG. 8, mobile device cover 802 can be selectively attached to a mobile device and the mobile device can be retained between an internal wall 838 and lip member 836.

It will be appreciated that a spring housing 868 can house a spring, a winding mechanism, and a catch mechanism as described above for retractable wire system 100. Further, a first end 814 of a wire 806 can be pulled through an aperture 820 to move the wire between a wound position (similar to wound position 206 shown in FIG. 1) and an unwound position (similar to unwound position 208 shown in FIG. 2). In this example, a second end of the wire is electrically coupled to and/or in data communication with the mobile device dock.

Thus, retractable wire system 800 functions to provide a mobile device accessory that is selectively attachable to a mobile device. The presently described system has the advantage that the user does not have to remember to additionally pack, store, and/or carry the mobile device accessory with the mobile device. Further, the presently described system has the advantage that the mobile device accessory does not have to be located and/or found by the user separately from the mobile device when use is desired. Additionally or alternatively, retractable wire system 800 can be used to maintain an untangled condition of a wire of the mobile device accessory during storage and/or transport of the mobile device accessory. Furthermore, retractable wire system 800 is configured to provide a protective covering for the associated mobile device and can be removed from the mobile device as desired by the user.

It will be appreciated that the described retractable wire systems can be used in combination with any mobile device accessory including a wire that is known or yet to be discovered. Further, it will be appreciated that the mobile device accessory including a wire can be used with a retractable wire system that is a portion of a cover for a mobile device or is integral to a mobile device.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A retractable wire system for a mobile device, comprising:
a wire, the wire configured to provide electrical communication between the mobile device and an accessory for the mobile device; and
a winding mechanism within a housing for the mobile device configured to releasably wind the wire, the wire being selectively moveable between a wound position and an unwound position.

2. The retractable wire system of claim 1, further comprising a spring and a spring housing, the spring and the winding mechanism being disposed within the spring housing, the spring being coupled to the winding mechanism, the wire being at least partially disposed within the spring housing and coupled to the winding mechanism, the spring being configured to bias the wire toward the wound position.

3. The retractable wire system of claim 2, wherein the winding mechanism further comprises a catch mechanism, the catch mechanism configured to releasably fix the wire in the unwound position, and
wherein the catch mechanism is further configured to be released to allow a biasing force of the spring to retract the wire into the wound position.

4. The retractable wire system of claim 1, wherein the housing is integral to a rear wall of the mobile device.

5. The retractable wire system of claim 4, wherein a first end of the wire is configured to be pulled by a user for moving the wire between the wound position and the unwound position, and a second end of the wire is electrically coupled to and in communication with at least one internal electrical component of the mobile device.

6. The retractable wire system of claim 5, wherein the mobile device accessory is at least one headphone and the first end of the wire has at least one speaker.

7. The retractable wire system of claim 5, wherein the mobile device accessory is a universal serial bus and the first end of the wire includes the universal serial bus.

8. The retractable wire system of claim 1, wherein the housing is a mobile device cover releasably attachable to an outer surface of the mobile device.

9. The retractable wire system of claim 8, wherein a first end of the wire is configured to be pulled by a user for moving the wire between the wound position and the unwound position, and a second opposing end of the wire is electrically coupled to and in communication with at least one electrical component of the mobile device.

10. The retractable wire system of claim 9, wherein the accessory is a headphone having at least one earpiece with a speaker at the first end of the wire.

11. The retractable wire system of claim 10, further comprising a male audio jack disposed on the second opposing end of the wire, the male audio jack being insertable into a female audio jack socket of the mobile device for electrically coupling the wire to the mobile device.

12. The retractable wire system of claim 10, further comprising a first electrical mating partner and a second electrical mating partner, the first electrical mating partner electrically coupled to the wire on the second opposing end of the wire and the second electrical mating partner on an outer surface of the mobile device and electrically coupled to the mobile device, the first electrical mating partner configured to make surface-to-surface contact with the second electrical mating partner for electrically coupling the wire to the mobile device.

13. The retractable wire system of claim 8, wherein the accessory is a universal serial bus.

14. The retractable wire system of claim 13, wherein the second opposing end of the wire is electrically coupled to a mobile device dock on an inner wall of the mobile device cover, the mobile device dock configured to be insertable into a receiving port of the mobile device.

15. A retractable wire system for a mobile device cover, the mobile device cover being releasably attachable to an outer surface of a mobile device, the retractable wire system comprising:
a body of the mobile device cover having an external wall, an internal wall, and a perimeter wall with an overhanging lip, the mobile device configured to be retained between the internal wall and the overhanging lip;
a wire, the wire configured to provide electrical communication between the mobile device and an accessory for the mobile device; and
a retractable winding mechanism within a retaining space between the external wall and the internal wall of mobile device cover, the retractable winding mechanism being configured to releasably wind the wire, the wire being moveable between a wound position and an unwound position.

16. The retractable wire system of claim 15, further comprising a spring and a spring housing, the spring and the retractable winding mechanism being disposed within the spring housing, the spring being coupled to the retractable winding mechanism, the wire being at least partially disposed within the spring housing and coupled to the retractable winding mechanism, the spring being configured to bias the wire toward the wound position.

17. The retractable headphone system of claim 15, wherein the retractable winding mechanism further comprises a catch mechanism, the catch mechanism configured to releasably fix the wire in the unwound position, and
wherein the catch mechanism is further configured to be released to allow a biasing force of the spring to retract the wire into the wound position.

18. A retractable wire system for a mobile device, the retractable wire system being integral to a body of the mobile device, the retractable wire system comprising:
an external wall of the mobile device, the external wall being on an opposing side of the mobile device relative to a display of the mobile device;
a wire, the wire configured to provide electrical communication between the mobile device and an accessory for the mobile device; and
a retractable winding mechanism integral to the external wall, the retractable winding mechanism being configured to releasably wind the wire, the wire being moveable between a wound position and an unwound position.

19. The retractable wire system of claim 18, further comprising a spring and a spring housing, the spring and the retractable winding mechanism being disposed within the spring housing, the spring being coupled to the retractable winding mechanism, the wire being at least partially disposed within the spring housing and coupled to the retractable winding mechanism, the retracting spring being configured to bias the wire toward the wound position.

20. The retractable headphone system of claim 17, wherein the winding mechanism further comprises a catch mechanism, the catch mechanism configured to releasably fix the wire in the unwound position, and
wherein the catch mechanism is further configured to be released to allow a biasing force of the spring to retract the wire into the wound position.
